(19) United States
(12) Patent Application Publication
(10) Pub. No.: US 2023/0066857 A1
(43) Pub. Date: Mar. 2, 2023

(54) DYNAMIC LASER EMISSION CONTROL IN LIGHT DETECTION AND RANGING (LIDAR) SYSTEMS

(71) Applicant: BEIJING VOYAGER TECHNOLOGY CO., LTD., Beijing (CN)

(72) Inventors: An-Chun Tien, Mountain View, CA (US); Wenbin Zhu, Beijing (CN); Chao Wang, Beijing (CN)

(73) Assignee: BEIJING VOYAGER TECHNOLOGY CO., LTD., Beijing (CN)

(21) Appl. No.: 17/462,534

(22) Filed: Aug. 31, 2021

(51) Int. Cl. G01S 7/481; G01S 17/89

(52) U.S. Cl. CPC G01S 7/4817; G01S 7/4814; G01S 17/89

(57) ABSTRACT

Embodiments of the disclosure provide a system for controlling an emission of laser beams by an optical sensing device. The system includes a controller configured to detect an object within a field of view based on a laser beam reflected by the object and received by the optical sensing device. The laser beam is emitted at a current scanning point according to a first laser emission scheme. The controller is also configured to determine a distance of the object from the optical sensing device. The controller is further configured to, in response to the distance being within a functional distance range, control the optical sensing device to emit laser beams according to a second laser emission scheme towards an aperture extending from the current scanning point. The second laser emission scheme reduces a number of scanning points in the aperture compared to the first laser emission scheme.

### TECHNICAL FIELD

The present disclosure relates to Light Detection and Ranging (LiDAR) systems, and more particularly to, systems and methods for dynamic laser emission control in the LiDAR systems.

### BACKGROUND

Optical sensing systems such as LiDAR systems have been widely used in autonomous driving and producing high-definition maps. For example, a typical LiDAR system measures the distance to a target by illuminating the target with pulsed laser light beams and measuring the reflected pulses with a sensor such as a photodetector. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and/or high-definition map surveys.

A LiDAR system can use a transmitter to transmits a signal (e.g., pulsed laser light) into the surroundings, and use a receiver to collect the returned signal (e.g., laser light reflected by an object in the surroundings). The LiDAR system can then calculate parameters such as the distance between the object and the LiDAR system based on, e.g., the speed of light and the time the signal travels (e.g., the duration of time between the time the signal is transmitted and the time the returned signal is received) and use the parameters to construct 3D maps and/or models of the surroundings. To improve the detection range and the signal-to-noise-ratio (SNR), laser light of high energy is often needed. On the other hand, however, the energy of the signal also needs to be limited to avoid potential harm to human eyes. Therefore, it is challenging to balance the performance demands and regulatory safety mandate in LiDAR system development.

Embodiments of the disclosure address the above challenges by providing improved systems and methods for dynamically controlling the laser emission used in LiDAR systems.

### SUMMARY

Embodiments of the disclosure provide a system for controlling an emission of laser beams by an optical sensing device. The system includes a controller configured to detect an object within a field of view of the optical sensing device based on a laser beam reflected by the object and received by the optical sensing device. The laser beam is emitted at a current scanning point according to a first laser emission scheme. The controller is also configured to determine a distance of the object from the optical sensing device based on the reflected laser beam. The controller is further configured to, in response to the distance being within a functional distance range, control the optical sensing device to emit laser beams according to a second laser emission scheme towards an aperture extending from the current scanning point. The second laser emission scheme reduces a number of scanning points in the aperture towards which laser beams are emitted compared to the first laser emission scheme.

Embodiments of the disclosure also provide a method for controlling an emission of laser beams by an optical sensing device. The method includes detecting an object within a field of view of the optical sensing device based on a laser beam reflected by the object and received by the optical sensing device. The laser beam is emitted at a current scanning point according to a first laser emission scheme. The method also includes determining a distance of the object from the optical sensing device based on the reflected laser beam. The method further includes, in response to the distance being within a functional distance range, controlling the optical sensing device to emit laser beams according to a second laser emission scheme towards an aperture extending from the current scanning point. The second laser emission scheme reduces a number of scanning points in the aperture towards which laser beams are emitted compared to the first laser emission scheme.

Embodiments of the disclosure also provide a non-transitory computer-readable medium having instructions stored thereon. When executed by at least one processor, the instructions can cause the at least one processor to perform a method for an emission of laser beams by an optical sensing device. The method includes detecting an object within a field of view of the optical sensing device based on a laser beam reflected by the object and received by the optical sensing device. The laser beam is emitted at a current scanning point according to a first laser emission scheme. The method also includes determining a distance of the object from the optical sensing device based on the reflected laser beam. The method further includes in response to the distance being within a functional distance range, controlling the optical sensing device to emit laser beams according to a second laser emission scheme towards an aperture extending from the current scanning point. The second laser emission scheme reduces a number of scanning points in the aperture towards which laser beams are emitted compared to the first laser emission scheme.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2A illustrates a block diagram of an exemplary LiDAR system, according to embodiments of the disclosure.

FIG. 2B illustrates a block diagram of an exemplary controller for controlling laser emission in a LiDAR system, according to embodiments of the disclosure.

FIG. 3A illustrates detection of objects in a field of view (FOV) of an exemplary LiDAR system, according to embodiments of the disclosure.

FIG. 3B illustrates variation of a size of a laser beam versus a travel distance in a FOV of an exemplary LiDAR system, according to embodiments of the disclosure.

FIG. 3C illustrates an exemplary emission scheme of a LiDAR system, according to embodiments of the disclosure.

FIG. 3D illustrates another exemplary emission scheme of a LiDAR system, according to embodiments of the disclosure.

FIGS. 4A-4D each illustrates an exemplary scenario of controlling laser emission in a LiDAR system, according to embodiments of the disclosure.

FIGS. 5A and 5B illustrate a flowchart of an exemplary method to control laser emission in a LiDAR system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

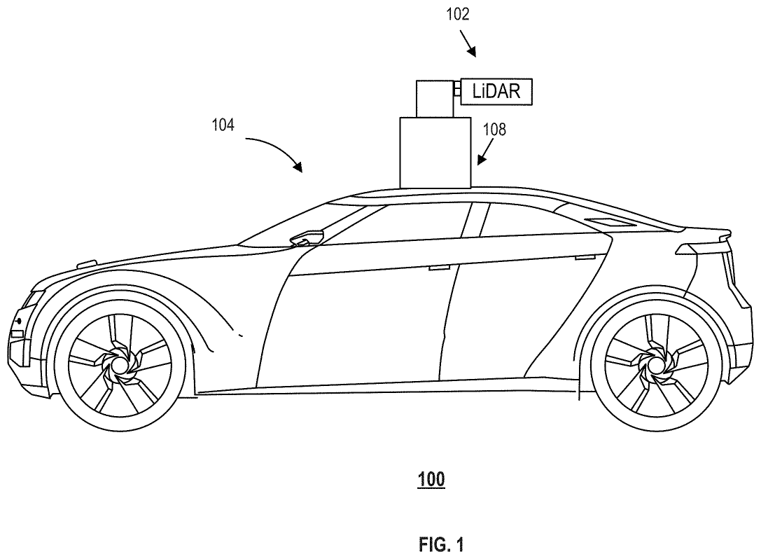

FIG. 1 illustrates a schematic diagram of an exemplary vehicle 100 equipped with a LiDAR system 102, according to embodiments of the disclosure. As illustrated in FIG. 1, vehicle 100 may be equipped with LiDAR system 102 mounted to body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. It is contemplated that the manners in which LiDAR system 102 can be equipped on vehicle 100 are not limited by the example shown in FIG. 1 and may be modified depending on the types of LiDAR system 102 and/or vehicle 100 to achieve desirable 3D sensing performance.

Consistent with some embodiments, LiDAR system 102 may be configured to capture data as vehicle 100 moves along a trajectory. For example, a transmitter of LiDAR system 102 is configured to scan the surrounding and acquire point clouds. LiDAR system 102 measures distance to a target by illuminating the target with pulsed laser light and measuring the reflected pulses with a receiver. The laser light used by LiDAR system 102 may be ultraviolet, visible, or near infrared. In some embodiments of the present disclosure, LiDAR system 102 may capture point clouds. As vehicle 100 moves along the trajectory, LiDAR system 102 may continuously emit/scan laser beams and receive returned laser beams.

Consistent with the present disclosure, a controller may be included for processing and/or analyzing collected data for various operations. For example, the controller may process received signals and control any operations based on the processed signals. The controller may also communicate with a remote computing device, such as a server (or any suitable cloud computing system) for operations of LiDAR system 102. Components of the controller may be in an integrated device or distributed at different locations but communicate with one another through a network. In some embodiments, the controller may be located entirely within LiDAR system 102. In some embodiments, one or more components of the controller may be located in LiDAR system 102, inside vehicle 100, or may be alternatively in a mobile device, in the cloud, or another remote location.

In some embodiments, the controller may process the received signal locally. In some alternative embodiments, the controller is connected to a server for processing the received signal. For example, the controller may stream the received signal to the server for data processing and receive the processed data (e.g., laser emission scheme(s) for controlling the laser power in an aperture) from the server. In some embodiments, the received signal is processed and the laser emission scheme(s) may be generated in real-time. A distance between the object and LiDAR system 102 may be updated in real-time for the determination of the laser emission scheme(s).

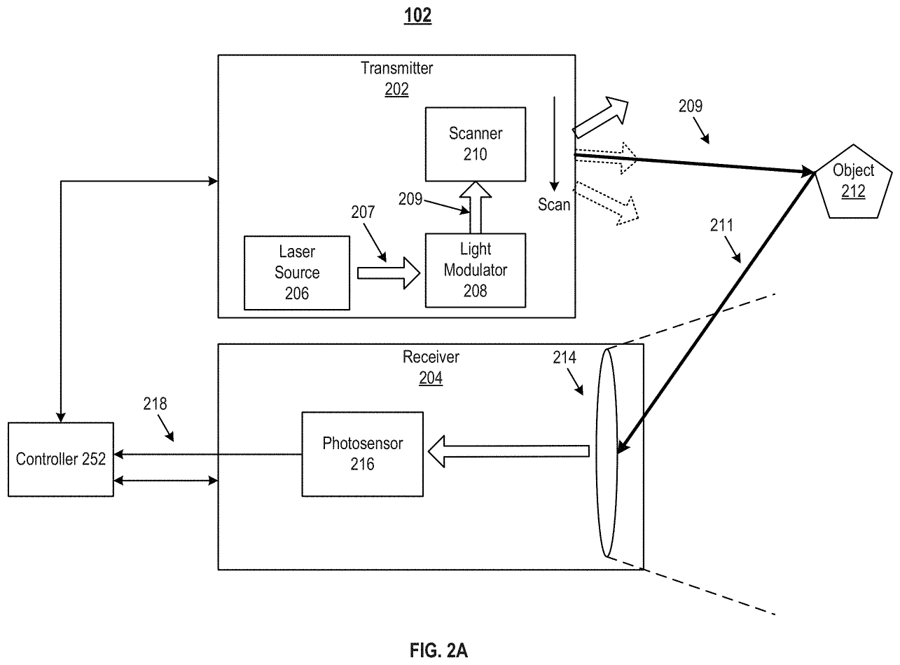

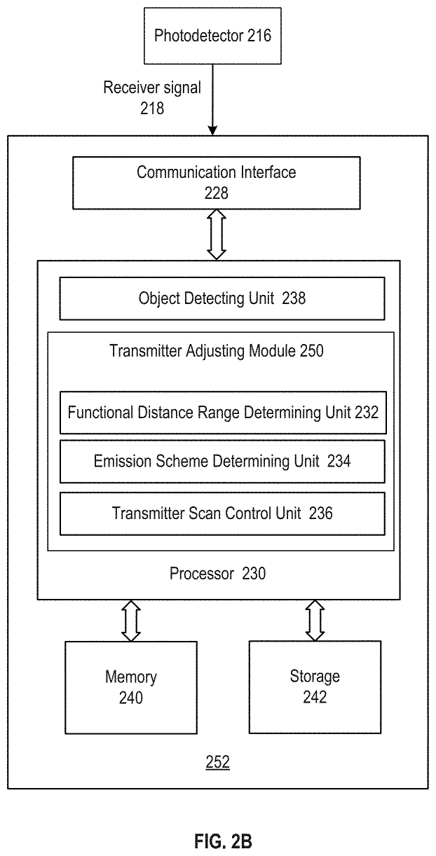

FIG. 2A illustrates a block diagram of an exemplary implementation of LiDAR system 102, according to embodiments of the disclosure. As shown in FIG. 2A, LiDAR system 102 has a transmitter 202 for emitting a laser beam 209 and a receiver 204 for collecting data of detected laser beams that include a returned laser beam 211 reflected by an object 212. Transmitter 202 may include any suitable light source that emits laser beam 209 outwardly into the surroundings of LiDAR system 102. In some embodiments, laser beam 209 includes a pulsed laser signal with a scanning angle, as illustrated in FIG. 2A.

Transmitter 202 may include any suitable components for generating laser beam 209 of a desired wavelength and/or intensity. For example, transmitter 202 may include a laser source 206 that generates a native laser beam 207 in the ultraviolet, visible, or near infrared wavelength range. Transmitter 202 may also include a light modulator 208 that collimates native laser beam 207 to generate laser beam 209. Scanner 210 can scan laser beam 209 at a desired scanning angle and a desired scanning rate. Each laser beam 209 can form a scanning point on a surface facing transmitter 202 and at a distance from LiDAR system 102. Laser beam 209 may, be incident on object 212, reflected back, and collected by a lens 214. Object 212 may be made of a wide range of materials including, for example, live objects, non-metallic objects, rocks, rain, chemical compounds, aerosols, clouds and even single molecules. The wavelength of laser beam 209 may vary based on the composition of object 212. In some embodiments of the present disclosure, scanner 210 may include optical components (e.g., lenses, mirrors) that can focus pulsed laser light into a narrow laser beam to increase the scan resolution.

Receiver 204 may be configured to detect returned laser beam 211 (e.g., returned signals) reflected from object 212. Upon contact, laser light can be reflected by object 212 via backscattering. Receiver 204 can collect returned laser beam 211 and output electrical signal indicative of the intensity of returned laser beam 211. As illustrated in FIG. 2A, receiver 204 may include lens 214 and a photosensor 216 (e.g., a photodetector or a photodetector array). Lens 214 may be configured to collect light from a respective direction in its field of view (FOV).

Photosensor 216 may be configured to detect returned laser beam 211 reflected by object 212. Photosensor 216 may convert the laser light (e.g., returned laser beam 211) collected by lens 214 into a receiver signal 218 (e.g., a current or a voltage signal). Receiver signal 218 may be generated when photons are absorbed in photosensor 216. Receiver signal 218 may be transmitted to a data processing unit, e.g., controller 252 of LiDAR system 102, to be processed and analyzed. Controller 252 may be configured to control transmitter 202 and/or receiver 204 to perform detection/sensing operations.

Receiver signal 218 may include the power data (e.g., an electrical signal) of returned laser beam 211, e.g., converted from the light signal of returned laser beam 211. Returned laser beam 211 may be caused by the reflection of laser beam 209 from object 212 in the FOV of LiDAR system 102. As shown in FIG. 2A, scanner 210 may emit/scan laser beam 209 in various directions towards the surroundings. Laser beam 209 may be incident on object 212 to cause returned laser beam 211 to be formed and reflected back toward LiDAR system 102. Photosensor 216 may receive returned laser beam 211 through lens 214. Photosensor 216 may convert returned laser beam 211 into an electrical signal (e.g., receiver signal 218), which is transmitted to controller 252. Controller 252 may further determine data and/or operations such as the distance of object 212 from LiDAR system 102 and subsequent laser emission scheme(s) of laser beam 209.

To obtain a desired coverage of the surroundings and/or the resolution of the scanning/sensing result, the energy of laser beam 209 needs to be sufficiently high for LiDAR system 102 to have a desirably long detection range. Object 212, far away from LiDAR system 102, can then be detected. Meanwhile, the energy of laser beam 209 should also be controlled below a safety limit to ensure human eyes are not impaired by the scanning. The span of the scanning angles of laser beam 209, e.g., in the three-dimensional (3D) space, also needs to be sufficiently large to cover a desired range of the surroundings laterally and vertically. The angular resolution of LiDAR system 102, e.g., the ability of LiDAR system 102 to measure the angular separation of the points, needs to be sufficiently high to ensure desirable spatial resolution for detecting object 212 far away from LiDAR system 102. Scanner 210 may perform two-dimensional scanning to cover the FOV of LiDAR system 102. In some embodiments, scanner 210 may scan laser beam 209 in the 3D space along a lateral scanning direction and a vertical scanning direction, e.g., line by line from left to the right and from top to bottom, at a desired scanning rate. Laser beam 209 may be emitted at various scanning points along the lateral and vertical scanning directions.

Controller 252 may determine the distance of object 212 from LiDAR system 102 based on receiver signal 218 and data of laser beam 209. For example, the distance between object 212 and LiDAR system 102 may be calculated based on the speed of light, the scanning angle of laser beam 209, the round-trip travel time of laser beam 209/211 (e.g., from transmitter 202 to object 212 and back to receiver 204), and/or the power of returned laser beam 211 (e.g., the intensity of the light signal converted by photosensor 216 to receiver signal 218). Controller 252 may sense object 212 and adjust the laser emission scheme of laser beam 209 when the distance between object 212 and LiDAR system 102 is equal to or less than a distance tolerance value (e.g., a distance below which unadjusted emission scheme of laser beam 209 in subsequent emissions would cause potential harm when object 212 is a human being or otherwise pose safety concerns). For example, to reduce or avoid the potential harm to human eyes, the laser emission scheme, after the adjustment, can cause the total power incident on an area covering the size of a human eye at the distance to be no higher than (e.g., lower than or equal to) a predetermined safety limit. In some embodiments, the adjustment of laser emission scheme is performed in real-time or near real-time. For example, if the distance between object 212 and LiDAR system 102 changes, controller 252 may dynamically adjust the laser emission scheme to ensure the total power incident on the area at the changed distance is less than the predetermined safety limit. For example, if the distance decreases, controller 252 may adjust the laser emission scheme so that the total power to be incident on the area does not exceed the predetermined safety limit. Functions of controller 252 for the determination of the distance or other triggers related to the potential harm and the adjustment of laser emission scheme of laser beam 209 are described in greater detail in connection with FIG. 2B.

FIG. 2B shows an exemplary implementation of controller 252, according to embodiments of the disclosure. Consistent with the present disclosure, controller 252 may receive receiver signal 218 (e.g., containing power data of returned laser beam 211) from photosensor 216.

In some embodiments, as shown in FIG. 2B, controller 252 may include a communication interface 228, a processor 230, a memory 240, and a storage 242. In some embodiments, controller 252 may have different modules in a single device, such as an integrated circuit (IC) chip (implemented as, for example, an application-specific integrated circuit (ASIC) or a field-programmable gate array (FPGA)), or separate devices with dedicated functions. In some embodiments, one or more components of controller 252 may be located in a cloud, or may be alternatively in a single location (such as inside vehicle 100 or a mobile device) or distributed locations. Components of controller 252 may be in an integrated device, or distributed at different locations but communicate with each other through a network.

Communication interface 228 may send data to and receive data from components such as photosensor 216 via wired communication methods, such as Serializer/Deserializer (SerDes), Low-voltage differential signaling (LVDS), Serial Peripheral Interface (SPI), etc. In some embodiments, communication interface 228 may optionally use wireless communication methods, such as a Wireless Local Area Network (WLAN), a Wide Area Network (WAN), wireless communication links such as radio waves, a cellular network, and/or a local or short-range wireless network (e.g., Bluetooth™), etc. Communication interface 228 can send and receive electrical, electromagnetic or optical signals that carry digital data streams representing various types of information.

Consistent with some embodiments, communication interface 228 may receive receiver signal 218 (e.g., containing data of returned laser beam 211). In some embodiments, communication interface 228 may sequentially receive receiver signals 218 as scanner 210 continues to scan laser beams 209 at the scanning rate. Communication interface 228 may transmit the received receiver signal 218 to processor 230 for processing.

Processor 230 may include any appropriate type of general-purpose or special-purpose microprocessor, digital signal processor, or microcontroller. Processor 230 may be configured as a stand-alone processor module dedicated to analyzing signals (e.g., receiver signal 218) and/or controlling the scan schemes. Alternatively, processor 230 may be configured as a shared processor module for performing other functions unrelated to signal analysis/scan scheme control.

In many LiDAR systems with laser wavelengths in near-infrared range, laser energy is strictly regulated due to its potential damage to human eyes. According to laser safety standards, e.g., the International Standard IEC 60285-1, the energy of a laser pulse (e.g., at a non-pulse-train mode) needs to meet a criterion described as Eₚᵤₗₛₑ≤AEL_{Class 1}, in which Eₚᵤₗₛₑ is the energy of the laser pulse/beam and AEL_{Class 1} is the accessible emission limit for Class 1 laser product. If the laser pulse is in a pulse train mode, in which the laser pulses are emitted continuously, the energy of a laser pulse needs to meet criteria described as Eₚᵤₗₛₑ≤AEL_{Class 1}×C₅, in which C₅ represents a correction factor related to the pulse number (N) in T2, T2 being about 10 seconds for near-infrared laser pulses. If N is much higher than the upper limit of laser pulses emitted (e.g., 600) in T2, C₅ is set to be equal to 0.4. That is, in pulse train mode, the energy of each pulse should be reduced to its original value (e.g., the value for non-pulse-train mode). A conventional approach to solve this problem for laser pulses emitted in the pulse train mode is, consistent with the criteria described above, reducing the energy of each laser pulse to 40% of its original value. For high resolution and long-range LiDAR systems, this becomes detrimental because the reduction of laser power can lead to a shorter detection range.

The present disclosure provides systems and methods for dynamically reducing the number (or angular resolution) of laser beams scanned towards an object when the object is detected to be at a short distance from the LiDAR system. The energy of a laser beam/pulse does not need to be reduced even when the LiDAR system is in a pulse train mode. When object 212 is detected to be in the short distance, the LiDAR system (e.g., via the controller) may determine an aperture, which covers the size of a human pupil, and adjust the laser emission scheme to a low-resolution emission scheme in the aperture, to ensure the total energy of the laser beams to be incident on the aperture does not exceed a predetermined safety limit (details of calculation provided below). The LiDAR system scans laser beams using a high-resolution emission scheme outside the aperture. If no object is detected at a short distance, the LiDAR system may continue to scan laser beams using the high-resolution emission scheme. The human eye is thus less susceptible to harm caused by the LiDAR system. Details of the embodiments are described in greater detail as follows.

As shown in FIG. 2B, processor 230 may include multiple functional units or modules that can be implemented using software, hardware, middleware, firmware, or any combination thereof. For example, processor 230 may include an object detecting unit 238, a transmitter adjusting module 250, or the like. In some embodiments, transmitter adjusting module 250 includes a functional distance range determining unit 232, an emission scheme determining unit 234, and a transmitter scan control unit 236. In some embodiments, processor 230 determines the laser emission scheme based on receiver signal 218 to ensure the total energy of laser pulses to be incident on the aperture is below a predetermined safety limit. Specifically, if object 212 is determined to be within a functional distance range, processor 230 may switch the laser emission to a low-resolution emission scheme, ensuring the total energy incident on the aperture does not exceed the predetermined safety limit; if object 212 is determined to be beyond the functional distance range, processor 230 may maintain the high-resolution emission scheme.

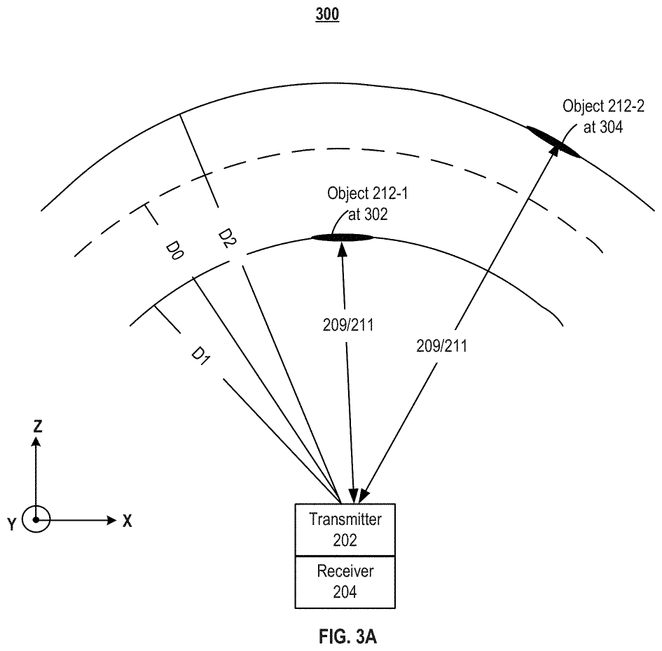

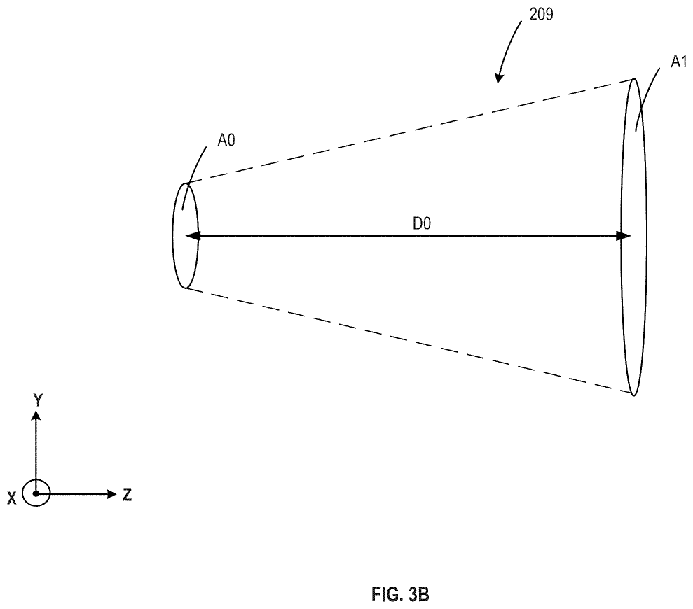

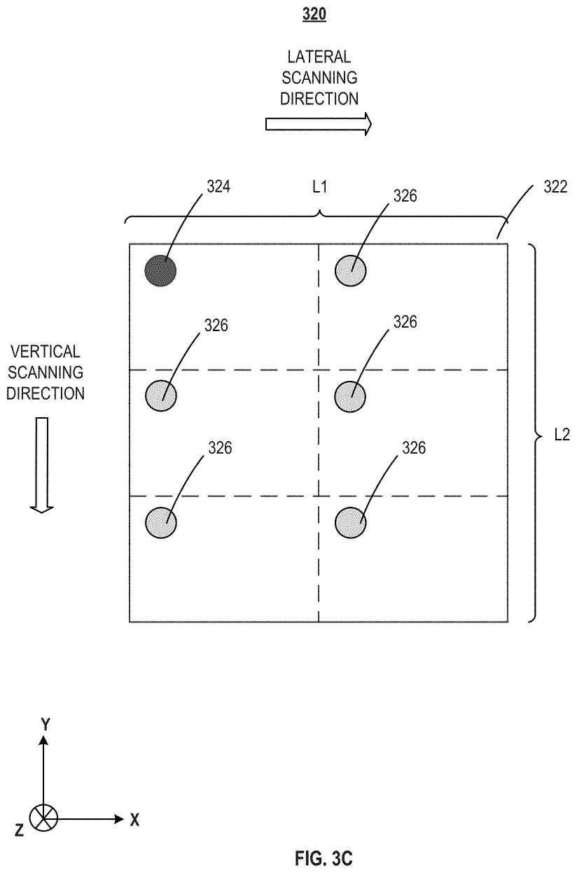

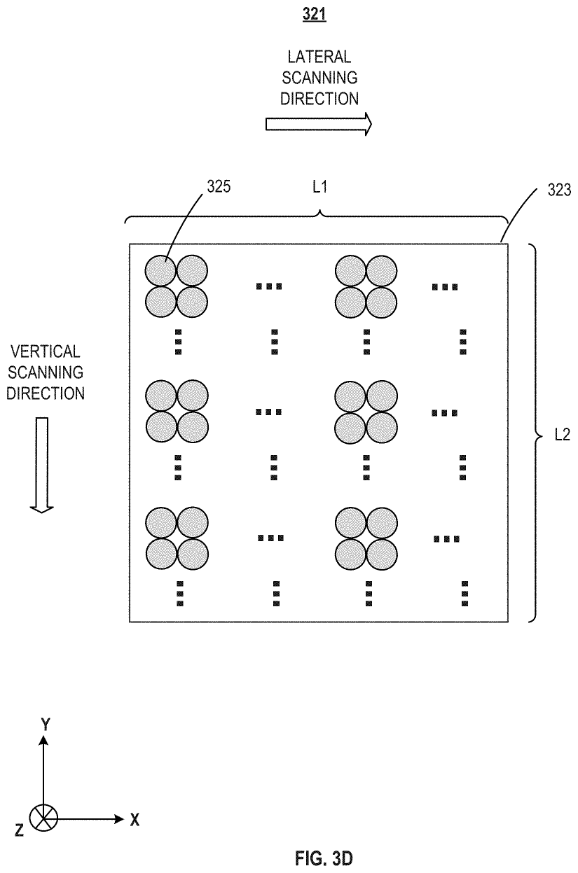

For ease of illustration, FIGS. 3A-3D are described together with FIG. 2B. FIG. 3A illustrates an exemplary FOV 300 of LiDAR system 102, according to embodiments of the present disclosure. FIG. 3B illustrates a size change of laser beam 209 during propagation, according to embodiments of the present disclosure. FIGS. 3C and 3D each illustrates an exemplary laser emission scheme, according to embodiments of the present disclosure.

Object detecting unit 238 may determine whether object 212 is subjected to potential harm by laser beam 209 and send an alert signal to transmitter adjusting module 250 after determining that object 212 is subject to potential harm. Transmitter adjusting module 250 may adjust the laser emission scheme accordingly. In some embodiments, object detecting unit 238 also sends to transmitter adjusting module 250 any data that can be used for the adjustment of laser emission scheme, such as the distance between object 212 and LiDAR system 102. In some embodiments, object detecting unit 238 determines object 212 is in the FOV of LiDAR system 102 based on receiver signal 218. Object detecting unit 238 may determine the distance between object 212 and LiDAR system 102 based on, e.g., the round-trip travel time of laser beams 209 and 211 and the scanning angle of scanner 210.

Object detecting unit 238 may compare, e.g., in real-time, the distance between LiDAR system 102 and object 212 with a distance tolerance value. For example, when the distance between LiDAR system 102 and object 212 is greater than the distance tolerance value, it may be determined that no harm can be caused by laser beam 209. On the other hand, when object detecting unit 238 determines that the distance between LiDAR system 102 and object 212 is equal to or less than the distance tolerance value, object detecting unit 238 may send an alert signal to transmitter adjusting module 250 to warn the potential risk. The distance tolerance value may be the upper limit of a functional distance range, and may be determined by functional distance range determining unit 232. Details of the functional distance range are described below.

Functional distance range determining unit 232 may determine a distance tolerance value which is the upper limit of a functional distance range. When the distance between object 212 and LiDAR system 102 is detected to be shorter than the distance tolerance value, object 212 may be determined to be in the functional distance range; when the distance between object 212 and LiDAR system 102 is detected to be greater than the distance tolerance value, object 212 may be determined to be beyond the functional distance range. As shown in FIG. 3A, controller 252 (not shown) may control transmitter 202 to scan laser beam 209 from transmitter 202 into FOV 300 of LiDAR system 102. Controller 252 may control transmitter 202 to scan laser beam 209 along various directions/angles within FOV 300 of LiDAR system 102. In some embodiments, transmitter 202 (e.g., via scanner 210) may scan laser beam 209 along a lateral scanning direction (e.g., the x-direction) and a vertical scanning direction (e.g., the y-direction). In an example, the scanning angle of laser beam 209 may include a vertical scanning angle and a lateral scanning angle. The vertical scanning angle may represent the direction of laser beam 209 with respect to the vertical direction (e.g., the y-direction), and the lateral scanning angle may represent the direction of laser beam 209 with respect to a lateral direction (e.g., the x-direction). At a fixed lateral scanning angle, transmitter 202 may incrementally change the vertical scanning angle of laser beam 209 by a vertical delta angle so one laser beam 209 and an immediately-subsequent laser beam 209 may be separated from each other by the vertical delta angle. The vertical delta angle may be any suitable value such as 0.01°, 0.02°, 0.05°, 0.1°, 0.2°, 0.5°, 1°, and the like. In some embodiments, transmitter 202 scans laser beam 209 from top to bottom in the 3D space at each lateral scanning angle. After scanning laser beam 209 at one lateral scanning angle, transmitter 202 may scan laser beam 209 from top to bottom in the 3D space at another lateral scanning angle, which may form a lateral delta angle with the previous lateral scanning angle. The lateral delta angle may be any suitable value such as 0.01°, 0.02°, 0.05°, 0.1°, 0.2°, 0.5°, 1°, and the like. In some embodiments, laser beam 209 is scanned in lines along the vertical scanning direction (referred to as “columns” herein) or in lines along the lateral scanning direction (referred to as “rows” herein). The rows and columns are perpendicular to each other in FOV 300.

In some embodiments, transmitter 202 repeatedly scans laser beam 209 vertically and laterally to cover FOV 300. Laser beam 209 may be emitted along its respective scanning direction within FOV 300 at the time it is being scanned. At any location in FOV 300, in a vertical plane facing laser beam 209, the scanning pattern of laser beams 209 may be formed by a plurality of scanning points, each scanning point corresponding to the position the scanned laser beam 209 intersects with the vertical plane. In other words, laser beams 209 emitted or to be emitted along a plurality of angles may be projected to the vertical plane to form the plurality of scanning points. In some embodiments, at a desired scanning rate, transmitter 202 may scan laser beam 209 a plurality of times (e.g., at different vertical scanning angles) at one lateral scanning angle before moving to the next lateral scanning angle. In some embodiments, transmitter 202 may scan laser beam 209 a plurality of times (e.g., at different lateral scanning angles) at one vertical scanning angle before moving to the next vertical scanning angle. In some embodiments, the lateral scanning angle, the vertical scanning angle, the lateral delta angles, the vertical delta angles, the scanning rate, and/or divergence characteristics of laser beam 209 may be used to determine the spatial/geometric distribution of laser beam 209 in the 3D space and the distribution of scanning points at any suitable surface/location.

As shown in FIG. 3A, DO represents the distance tolerance value, which is the upper limit of functional distance range from transmitter 202. If object 212 is detected to be at a location 302, of which the distance to transmitter 202 is smaller than distance tolerance value DO, object 212 is determined to be in the functional distance range. If object 212 is detected to be at a location 304, of which the distance to transmitter 202 is greater than distance tolerance value D0, object 212 is detected to be beyond the functional distance range.

Functional distance range determining unit 232 may determine distance tolerance value D0. As previously described, in pulse train mode, the energy of each laser pulse conventionally needs to be reduced to 40% of its original value (e.g., by multiplying correction factor Cs) to ensure the total energy of all laser pulses incident on an aperture that covers the size of a pupil does not exceed the predetermined safety limit. In the present application, when object 212 is detected to be in the functional distance range, instead of reducing energy of laser beam 209, controller 252 may maintain the original energy of each laser beam 209 and reduce the number of pulses/scanning points towards the aperture such that the total energy of laser beam 209 incident on the aperture does not exceed the predetermined safety limit. Functional distance range determining unit 232 may determine distance tolerance value D0 based on the divergence characteristics of laser beam 209. In some embodiments, functional distance range determining unit 232 determines the value of distance tolerance value D0. At distance tolerance value D0, even if no pulses/scanning points are reduced, the total energy incident on a pupil (or the aperture) would not be amount to a harmful level. In some embodiments, functional distance range determining unit 232 is an optional part of processor 230, and distance tolerance value D0 is a predetermined value and stored in controller 252 (e.g., in memory 240 and/or storage 242). For example, DO may be an unchanged value determined prior to the scanning process. In some embodiments, the divergence characteristics of laser beam 209 is determined during the design of LiDAR 102, and distance tolerance value D0 is determined, e.g., to be a fixed value, during the design. In operation, processor 230 may access memory 240 and/or storage 242, obtain distance tolerance value D0, and employ distance tolerance value D0 in calculations.

As shown in FIG. 3B, laser beam 209 may propagate in the z-direction during the two-dimensional scanning. A beam size (e.g., an area) of laser beam 209 in the x-y plane (e.g., a vertical plane facing laser beam 209) may increase as laser beam 209 travels away from transmitter 202 due to the divergence characteristics of laser beam 209. Assuming the beam size of laser beam 209 is A0 at transmitter 202 and A1 at distance tolerance value D0, A1 is greater than A0. A0 may be assumed to be comparable to, e.g., equal to or greater than the size/area of a human pupil. When A1 increases to 2.5 times of A0 (e.g., A1/A0=2.5), the laser energy per area at A1 is 40% of that at A0. That is, even without reducing any scanning points, the total energy incident on a human eye at distance tolerance value D0 with no energy reduction on each pulse, is equivalent to that at transmitter 202 with an energy reduced to 40% for each pulse. In other words, if the distance between object 212 and transmitter 202 is at least DO, object 212 is not susceptible to harm by laser beam 209 even with no energy reduction or skipped scanning points. Distance tolerance value D0, as determined by functional distance range determining unit 232, may then have a value at which the value of A1 is 2.5 times the value of A0.

Emission scheme determining unit 234 may determine the laser scanning scheme at which laser beam 209 is scanned into FOV 300. Specifically, emission scheme determining unit 234 may determine the emission scheme of laser beam 209 when object 212 is detected to be in the functional distance range. The emission scheme may ensure the total energy of laser beam 209 to be incident on a human pupil does not exceed the predetermined safety limit before laser beam 209 propagates to the upper limit of functional distance range. The predetermined safety limit for the energy of the aperture, as determined by emission scheme determining unit 234, may be calculated as the total energy incident on the aperture in the function distance with the minimum number of scanning points for a high-resolution scan and 40% pulse energy. For example, emission scheme determining unit 234 may assume laser beam 209 is scanned at a minimum number of scanning points towards the aperture covering a human pupil (e.g., a 7-mm circular area) in T2 (e.g., 10 seconds). In some embodiments, emission scheme determining unit 234 determines the minimum number of scanning points to be 600. Assuming the frame rate of LiDAR system 102 is 10 frame per second (fps), the predetermined safety limit may then be equal to the total energy of laser beam 209, at its original energy and 6 scanning points per frame, towards the aperture. Emission scheme determining unit 234 may determine an emission scheme that includes six scanning points evenly distributed in the aperture that covers the 7-mm circular area. In some embodiments, the aperture has a 7×7 mm squared shape in a two-dimensional scanning that has a lateral scanning direction and a vertical scanning direction. In some other embodiments, the aperture can be determined based on the scanning directions and may have other shapes such as a rectangular shape or a circular shape.

FIG. 3C illustrates an exemplary emission scheme 320 according to which laser beam 209 is emitted when object 212 is detected to be in the functional distance range, according to some embodiments. The frame rate of LiDAR system 102 is assumed to be 10 fps. Emission scheme 320 may be referred to as a low-resolution emission scheme. As shown in FIG. 3C, scanning point 324 represents a scanning point at which object 212 is detected in the functional distance range and emission scheme 320 may include six scanning points, including scanning point 324 (e.g., the current scanning point) evenly distributed in an aperture 322 extending from scanning point 324. Scanning point 324 may be the first scanning point in the aperture along the scanning directions, and scanning points 326 may represent the other five unscanned scanning points in aperture 322 when emission scheme 320 is applied. Aperture 322 may extend from scanning point 324, and along the two-dimensional scanning directions, e.g., lateral and vertical scanning directions. The area/size of aperture 322 is sufficient to cover the area of a human pupil, which is often considered as a 7-mm circular area. In some embodiments, aperture 322 has a squared shape that can cover the 7-mm circular area and includes least skipped scanning points. For example, a lateral dimension L1 of aperture 322 may be about 7 mm, and a vertical dimension L2 of aperture 322 may be about 7 mm. In aperture 322, a distance between adjacent scanning points in the lateral scanning direction is the same, and a distance between adjacent scanning points in the vertical scanning direction is the same. In an example, controller 252 may apply emission scheme 320 when object 212 is detected at location 302 based on returned laser beam 211 at scanning point 324.

In some embodiments, according to emission scheme 320, transmitter 202 scans laser beam 209 at five more other scanning points, e.g., scanning points 326, sequentially along the scanning directions after the scanning of scanning point 324 is completed. At each scanning point (e.g., 326) other than the first scanning point (e.g., 324) in aperture 322, object detecting unit 238 may determine whether object 212 is detected in the functional distance range, and transmitter scan control unit 236 may adjust the laser emission scheme accordingly. For example, if object 212 is detected in the functional distance range at one of scanning points 326 (e.g., the current scanning point), transmitter scan control unit 236 may start to scan laser beam 209 at five more scanning points in an aperture extending from the current scanning point 326.

FIG. 3D illustrates part of an exemplary emission scheme 321 according to which laser beam 209 is emitted when no object 212 is detected to be in the functional distance range, according to embodiments. Emission scheme 321 may be referred to as a high-resolution emission scheme. As shown in FIG. 3D, emission scheme 321 includes a plurality of scanning points 325 distributed continuously (e.g., with no skipped scanning points) in the lateral scanning direction and the vertical scanning direction. No object 212 is detected within the functional distance range as a result of the scan performed at any scanning points 325.

For ease of illustration, an aperture 323 in FIG. 3C is depicted to have the same shape and dimensions as aperture 322 FIG. 3D. As shown in FIGS. 3C and 3D, one or more scanning points along lateral scanning direction and/or vertical scanning direction (e.g., between adjacent scanning points 324 and 326, and between adjacent scanning points 324 and 324), are skipped. That is, in the same area (e.g., the area covered by aperture 322), the total number (e.g., six) of scanning points 324 and 326 is reduced. The scanning points in aperture 322 is a subset of scanning points in aperture 323. Even assuming a human eye is located at aperture 322 in the functional distance range, no potential harm can be caused by laser beam 209. In an example, controller 252 may apply emission scheme 321 when object 212 is detected at location 304 or no object 212 is detected.

Referring back to FIG. 2B, transmitter scan control unit 236 may determine the emission scheme applied by transmitter 202. For each scanning point, after receiving the alert signal from object detecting unit 238, transmitter scan control unit 236 may determine whether the current emission scheme needs to be changed or maintained. In an example, if LiDAR system 102 is scanning FOV 300 using emission scheme 321 and the alert signal suggests object 212 is detected in the functional distance range at the current scanning point, transmitter scan control unit 236 may control transmitter 202 to start scanning laser beam 209 according to emission scheme 320 from the current scanning point. In another example, if LiDAR system 102 is scanning FOV 300 using emission scheme 320 and the alert signal suggests object 212 is detected in the functional distance range at the current scanning point, transmitter scan control unit 236 may re-apply emission scheme 320 from the current scanning point and control transmitter 202 to scan accordingly. In a further example, if LiDAR system 102 is scanning FOV 300 using emission scheme 320 and the alert signal suggests no object 212 is detected in the functional distance range at any scanning point in the aperture, transmitter scan control unit 236 may control transmitter 202 to scan laser beam 209 using emission scheme 321 at the next scanning point, e.g., the first scanning point outside of the aperture. In some embodiments, if object 212 is detected beyond the functional distance range at the current scanning point, transmitter scan control unit 236 also controls transmitter 202 to scan laser beam 209 using emission scheme 321 outside the aperture.

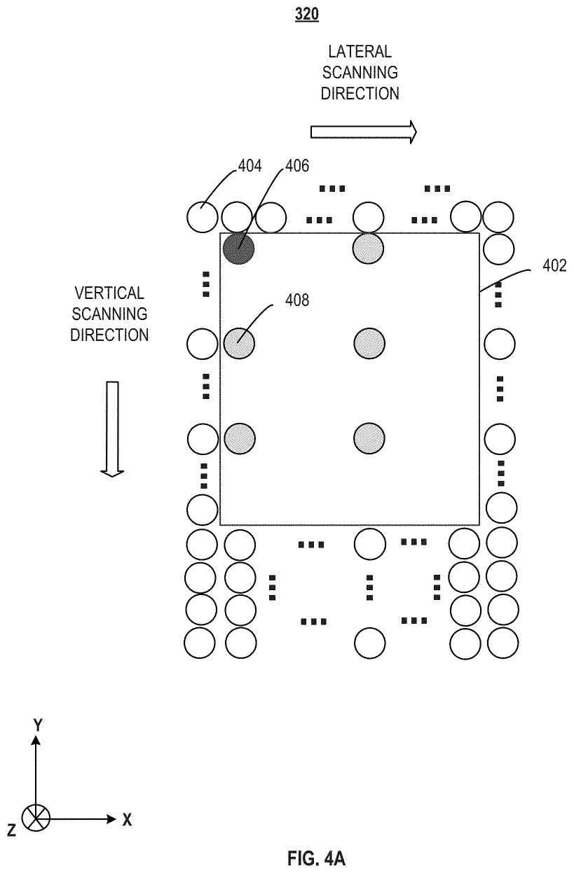

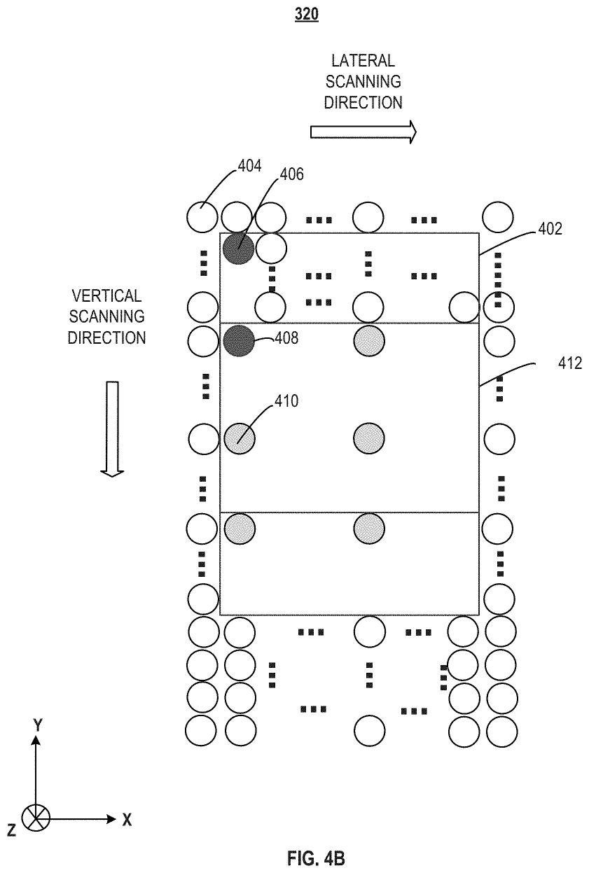

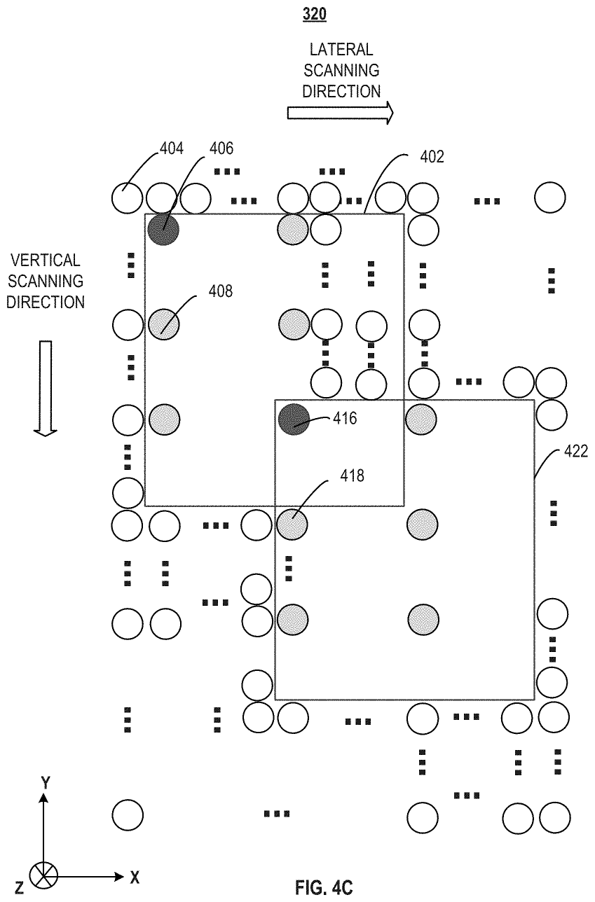

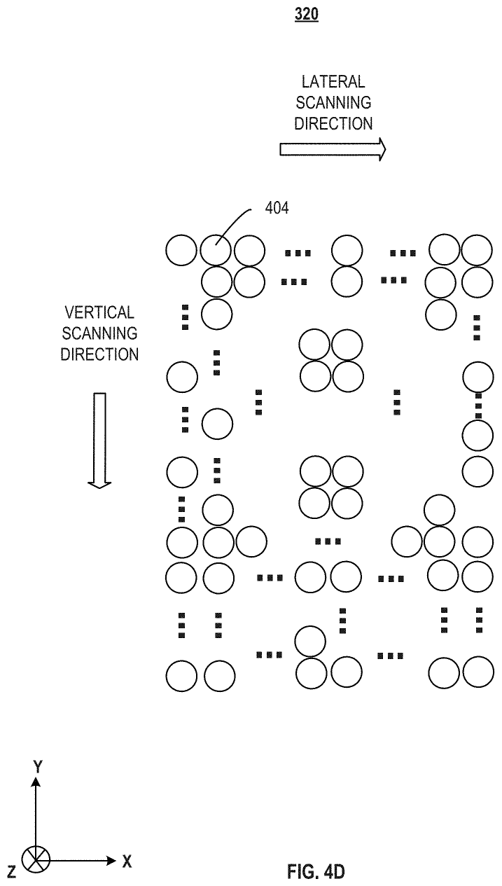

Units 232-236 (and any corresponding sub-modules or sub-units) and module 250 can be hardware units (e.g., portions of an integrated circuit) of processor 230 designed for operation independently or with other components or software units implemented by processor 230 through executing at least part of a program. The program may be stored on a computer-readable medium. When the program is executed by processor 230, the executed program may cause processor 230 to perform one or more functions or operations. Although FIG. 2B shows units 232-236 all within one processor 230, it is contemplated that these units may be distributed among multiple processors located close to or remotely with each other. The functions of units 232-236 and module 250 are described in greater detail as follows in connection with FIGS. 4A-4C.

Memory 240 and storage 242 may include any appropriate type of mass storage provided to store any type of information that processor 230 may need to operate. Memory 240 and/or storage 242 may be volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, a static RAM, a hard disk, an SSD, an optical disk, etc. Memory 240 and/or storage 242 may be configured to store one or more computer programs that may be executed by processor 230 to perform functions disclosed herein. For example, memory 240 and/or storage 242 may be configured to store program(s) that may be executed by processor 230 to analyze LiDAR signals and control the scanning schemes of laser beams.

Memory 240 and/or storage 242 may be further configured to store/cache information and data received and/or used by processor 230. For instance, memory 240 and/or storage 242 may be configured to store/cache receiver signal 218, data of laser beam 209, and the corresponding tolerance values indicating the safety limits, and calculation results obtained by different units of processor 230. The various types of data may be stored permanently, removed periodically, or disregarded immediately after each frame of data is processed.

FIGS. 4A-4D each illustrates an exemplary FOV 300 of LiDAR system 102, according to embodiments of the present disclosure. Specifically, FIGS. 4A-4C each illustrates a scenario when object 212 is detected in the functional distance range, and FIG. 4D illustrates a scenario when no object 212 is detected in the functional distance range. In the embodiments illustrated in FIGS. 4A-4C, the frame rate of LiDAR system 102 is assumed to be 10 fps.

As shown in FIG. 4A, transmitter scan control unit 236 may control transmitter 202 to start scanning laser beam 209 according to a first emission scheme along the lateral scanning direction and the vertical scanning direction. The first emission scheme may be an example of emission scheme 321. Transmitter scan control unit 236 may also control the energy of laser beam 209, emitted by transmitter 202, to be under a respective safety limit, e.g., AEL_{Class 1}, Scanning points 404 represent those at which laser beam 209 is scanned according to the first emission scheme.

In some embodiments, at a scanning point 406, object 212 is detected to be in the functional distance range based on returned laser beam 211. Object detecting unit 238 may send an alert signal to transmitter adjusting module 250 indicating the detection result. In response to the alert signal, transmitter scan control unit 236 may switch from the first emission scheme to a second emission scheme along the lateral scanning direction and the vertical scanning direction. The second emission scheme may be an example of emission scheme 320.

In some embodiments, to start the second emission scheme, transmitter scan control unit 236 controls transmitter 202 to start scanning laser beam 209 at five more scanning points towards an aperture 402 that extends from scanning point 406. In some embodiments, aperture 402 is an example of aperture 322. In an example, transmitter 202 scans laser beam 209 at a column of scanning points along the vertical scanning direction before moving along the lateral scanning direction to the next column. As shown in FIG. 4A, transmitter scan control unit 236 may control transmitter 202 to skip one or more scanning points in the vertical scanning direction and scan laser beam 209 at scanning point 408 after scanning point 406.

In some embodiments, object 212 may be detected in the functional distance range at one of the subsequent scanning points in aperture 402. For example, as shown in FIG. 4B, object 212 may be detected in the functional distance range at scanning point 408, which is the second scanning point to be scanned in aperture 402. In that case, an alert signal may be generated by object detecting unit 238. After receiving the alert signal from object detecting unit 238, transmitter scan control unit 236 may apply the second emission scheme from the current scanning point, e.g., 408. That is, transmitter scan control unit 236 may control transmitter 202 to scan laser beam 209 at five more scanning points 410 in an aperture 412 extending from the current scanning point 408. At each scanning point 410, transmitter scan control unit 236 may determine whether the second emission scheme needs to be applied from the current scanning point.

Transmitter scan control unit 236 may control transmitter 202 to scan laser beam 209 in the first emission scheme outside the aperture. The aperture may be the most-recently determined aperture in which the second emission scheme is applied. In an example, as shown in FIG. 4B, assuming, as transmitter 202 continues to scan laser beam 209 vertically towards aperture 412, object 212 is not detected in the functional distance range at the two scanning points 410 in aperture 412, transmitter scan control unit 236 may resume the first emission scheme for the current column outside aperture 412 in the vertical scanning direction. That is, transmitter 202 may start scanning laser beam 209 continuously, outside aperture 412, in the vertical scanning direction in FOV 300. After the scanning of current column is completed, transmitter 202 may start scanning the next column of scanning points. As shown in FIG. 4B, transmitter scan control unit 236 may control transmitter 202 to start scanning laser beam 209 according to the first emission scheme until a boundary, e.g., an upper boundary, of aperture 412 is reached. Transmitter scan control unit 236 may resume the second emission scheme in aperture 412, e.g., by controlling transmitter 202 to skip any scanning points along the vertical scanning direction according to the distribution of the scanning points in the second emission scheme. Transmitter scan control unit 236 may resume the first emission scheme when another boundary, e.g., a lower boundary, of aperture 412 is reached. As shown in FIG. 4B, transmitter 202 may scan laser beams 209 continuously in the current columns outside aperture 412 in the vertical scanning direction.

In some embodiments, if object 212 is not detected in the functional distance range at a current scanning point in aperture 402 and the current scanning point is not the last scanning point in aperture 402, transmitter scan control unit 236 controls transmitter 202 to continue scanning laser beam 209 at a next scanning point in aperture 402, according to the current second emission scheme, along the scanning directions. In an example, as shown in FIG. 4C, after object 212 is detected in the functional distance range at scanning point 406, transmitter scan control unit 236 may apply the second emission scheme from scanning point 406. Along the scanning direction(s), transmitter 202 may scan scanning points 404 outside aperture 402 and any of the five more scanning points, e.g., 408 and 416 in aperture 402. Meanwhile, transmitter 202 may scan laser beam 209 continuously according to the first emission scheme outside aperture 402. Assuming object 212 is not detected in the functional distance range at any scanning point 408 except for the last scanning point 416 in aperture 402, transmitter scan control unit 236 may control transmitter 202 to start scanning laser beam 209 according to the second emission scheme from scanning point 416. That is, transmitter 202 may scan five more scanning points in an aperture 422 extending from scanning point 416. Aperture 422 may be an example of aperture 322. As shown in FIG. 4C, transmitter scan control unit 236 may control transmitter 202 to scan laser beam 209 continuously at scanning points 404 outside aperture 422 and scan five more scanning points 418 sequentially in aperture 422.

In some embodiments, referring back to FIG. 4A, object 212 is not detected in the functional distance range during the scans performed at any of the five more scanning points (e.g., 408) in aperture 402, except for the first scanning point (e.g., 406), transmitter scan control unit 236 may control transmitter 202 to scan laser beam 209 at the five more scanning points along the scanning directions, e.g., sequentially, in aperture 402. Meanwhile, transmitter 202 may scan scanning points 404 continuously, e.g., according to the first emission scheme, outside aperture 402.

In some embodiments, if object 212 is not detected in the functional distance range in any scanning points 404, transmitter scan control unit 236 may control transmitter 202 to scan laser beam 209 continuously, e.g., according to the first emission scheme, in FOV 300, as shown in FIG. 4D, or until object 212 is detected in the functional distance range.

It should be noted that, the location of an aperture can be arbitrary and is determined based on the location of object 212, and should not be limited by the embodiments of the present disclosure. For illustrative purposes, in FIGS. 4A-4C, apertures are depicted to extend from scanning points each below the first scanning point of a column. However, in various embodiments, if object 212 is detected at the functional distance range at the first scanning point of a column, transmitter scan control unit 236 may apply the second emission scheme from the first scanning point (e.g., the current scanning point), and control transmitter 202 to scan five more scanning points in an aperture extending from the first scanning point. In some embodiments, if object 212 is detected in the functional distance range at a scanning point close to the end of a column (e.g., the bottom of a column) such that an aperture extending from the scanning point would exceed the boundary/boundaries of FOV 300, transmitter scan control unit 236 may skip any of the five more scanning points in the aperture that exceed FOV 300.

It should also be noted that, the shape and the extending directions of the aperture, should be determined based on the scanning directions of LiDAR system 102, and should not be limited by the embodiments of the present disclosure. According to the second emission scheme, the current scanning point, e.g., the scanning point at which object 212 is detected in the functional distance range, should be the first scanning point in the aperture. The aperture should include the current scanning point and extend along the scanning directions to include other unscanned scanning points. The shape of the aperture may be chosen to minimize the number of skipped scanning points.

It should also be noted that, the number and distribution of scanning points in the aperture should be determined based on the design of LiDAR system 102 and should not be limited by the embodiments of the present disclosure. The number of scanning points may be determined, partially or fully, based on the predetermined safety limit, which is a value to ensure no potential harm can be caused to a human eye even if the human eye is located at the same location of transmitter 202. The predetermined safety limit is, partially or fully, determined based on the frame rate of LiDAR system 102. For example, a different frame rate can result in a different predetermined safety limit. The predetermined safety limit can also be determined using any suitable way and have other suitable values. The distribution of the scanning points may optimize the spatial resolution and/or detectability of object 212 in the aperture.

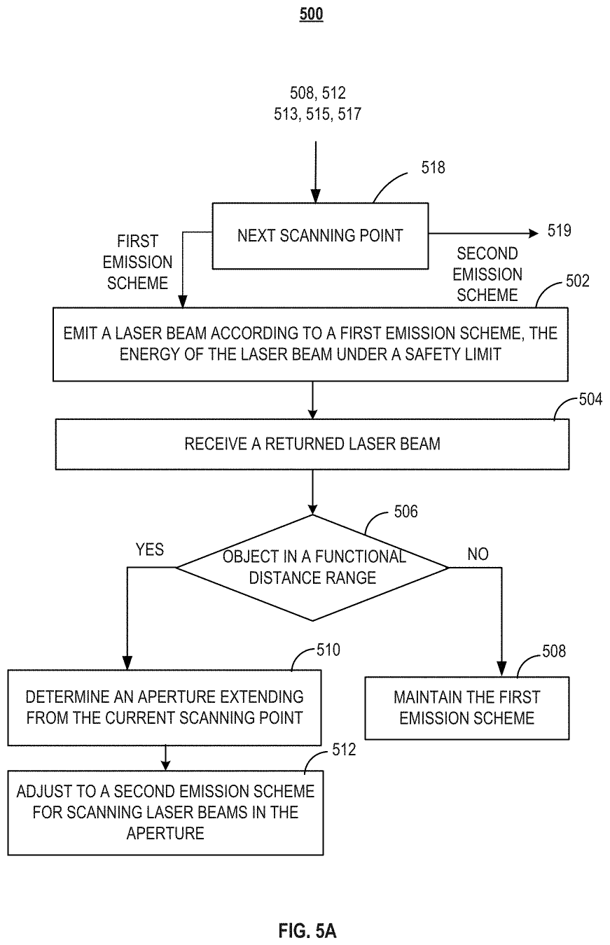

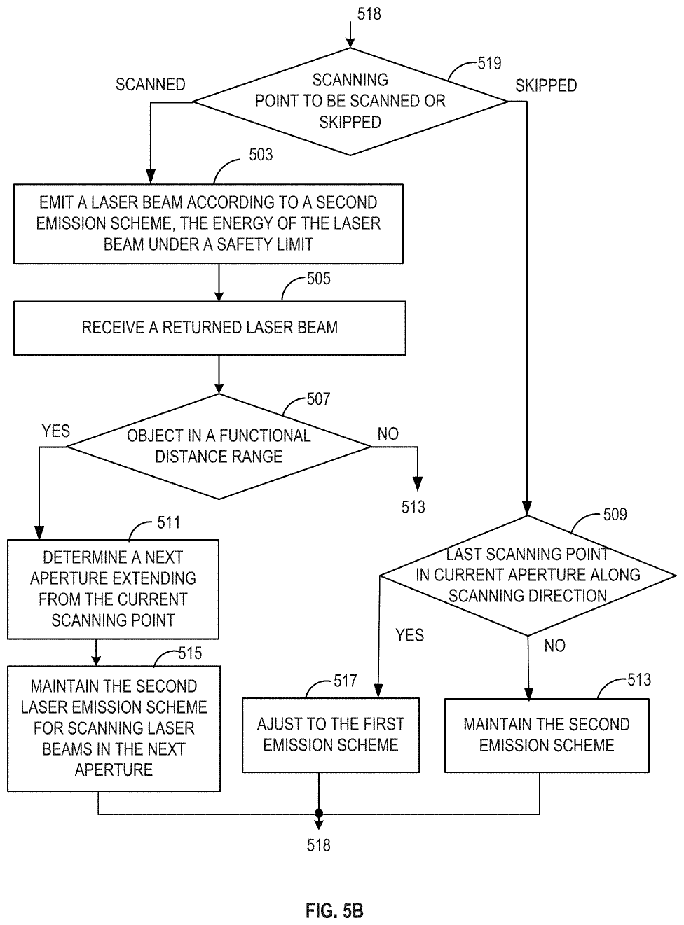

FIGS. 5A and 5B illustrate a flow chart of an exemplary method 500 for controlling the emission scheme of laser beam 209 to limit its power to be incident on an aperture, according to some embodiments. FIG. 5B is a continuation of FIG. 5A, according to some embodiments. FIGS. 5A and 5B together illustrate a process that determines the emission scheme for a single scanning point, e.g., the current scanning point, in the scanning of a frame. For ease of illustration, method 500 is described with FIGS. 3A-3D and 4A-4D.

Method 500, as illustrated in FIG. 5A, starts at step 502, in which a laser beam is emitted according to a first emission scheme, and the power of the laser beam is under a safety limit. Controller 252 may control transmitter 202 to start emitting laser beam 209 according to the first emission scheme (e.g., 321), which is a high-resolution emission scheme, towards FOV 300. Controller 252 may control the energy of laser beam 209 to be below a predetermined safety limit. At step 504, a returned laser beam is received. Controller 252 may receive receiver signal 218 reflecting the energy of returned laser beam 211. At step 506, it is determined whether an object is detected in the functional distance range. Controller 252 may determine whether object 212 is detected in the functional distance range based on receiver signal 218. Controller 252 may determine whether object 212 is detected in the functional distance range based on a comparison between the distance from object 212 to receiver 204 and distance tolerance value D0. If the distance from object 212 to receiver 204 is less than distance tolerance value D0, object 212 is determined to be in the functional distance range, and operation is directed to step 510. If the distance from object 212 to receiver 204 is greater than distance tolerance value D0, no object 212 is determined to be in the functional distance range, and method 500 proceeds to step 508.

At step 510, an aperture is determined extending from the current scanning point along scanning directions. Controller 252 may determine an aperture extending from the current scanning point (e.g., 324, 406, and 416) and extending in the lateral and vertical scanning directions. The size of the aperture can cover the area of a human pupil. In some embodiments, the aperture has a squared shape. At step 512, the emission scheme of transmitter 202 is adjusted to a second emission scheme for scanning laser beams in the aperture. Controller 252 may switch to a second emission scheme (e.g., 322), which is a low-resolution emission scheme, for scanning laser beam 209 towards the aperture. In some embodiments, the second emission scheme defines a scanning pattern that includes the current scanning point and five more unscanned scanning points. After step 512, the operation is then directed to step 518 where the laser beam is moved/rotated towards the next scanning point. Controller 252 may control transmitter to move/rotate laser beam 209 to the desired orientation and maintain the second emission scheme. In some embodiments, controller 252 may determine the orientation of laser beam 209 based on the coordinates of the current scanning point.

At step 508, the first emission scheme is maintained. Controller 252 may maintain first emission scheme if no object 212 is detected to be in the functional distance range. After step 508, the operation is also directed to step 518 where the laser beam is moved/rotated towards the next scanning point. If the current scanning point is the last scanning point of the current frame, at step 518, the next scanning point the laser beam is moved/rotated towards will be the first scanning point of the next frame.

As illustrated in FIG. 5B, at step 519, it is determined whether the scanning point, in the current aperture, is to be scanned or skipped. Controller 252 may determine whether the scanning point is one of the five scanning points (e.g., 326, 408, 410, and 418) to be scanned in the aperture, or one of the plurality of scanning points to be skipped in the aperture. If it is determined the scanning point is to be scanned, the operation is directed to step 503. If it is determined the scanning point is to be skipped, the operation is directed to step 509. At step 503, a laser beam is emitted according to the second emission scheme, and the power of the laser beam is under a safety limit. Controller 252 may control transmitter 202 to emit laser beam 209 according to the second emission scheme (e.g., 320), which is a low-resolution emission scheme, towards the current aperture (e.g., 322, 402, 412, 422). Controller 252 may control the energy of laser beam 209 to be below the predetermined safety limit. At step 505, a returned laser beam is received. Controller 252 may receive receiver signal 218 reflecting the energy of returned laser beam 211. At step 507, whether an object is detected in the functional distance range is determined. Controller 252 may determine whether object 212 is detected in the functional distance range based on receiver signal 218. Controller 252 may determine whether object 212 is detected in the functional distance range based on a comparison between the distance from object 212 to receiver 204 and distance tolerance value D0. If the distance from object 212 to receiver 204 is less than distance tolerance value D0, object 212 is determined to be in the functional distance range, and method 501 proceeds to step 511. If the distance from object 212 to receiver 204 is greater than the distance tolerance value D0, object 212 is determined to be not in the functional distance range, and operation is directed to step 513.

At step 511, a next aperture is determined extending from the current scanning point along the scanning directions. Controller 252 may determine a next aperture (e.g., 412, 422) extending from the current scanning point (e.g., 408 and 416) and extending in the lateral and vertical scanning directions in the functional distance range. The size of the next aperture can cover the area of a human pupil. In some embodiments, the next aperture has a squared shape. At step 515, the second emission scheme is maintained for scanning laser beams in the next aperture. Controller 252 may maintain the second emission scheme (e.g., 320, a low-resolution emission scheme) for scanning laser beam 209 towards the next aperture.

At step 509, it is determined whether the current scanning point is the last scanning point in the current aperture along the scanning direction. Controller 252 may determine whether the current scanning point (the skipped scanning points in aperture 402 or 412) is the last scanning point in the current aperture (e.g., 402 or 412), e.g., along the vertical scanning direction. If the current scanning point is determined to be the last scanning point in the current aperture along the scanning direction, the operation is directed to step 517. Otherwise, the operation is directed to step 513. At step 517, the emission scheme is adjusted to the first emission scheme. If controller 252 determines the current scanning point is the last scanning point in the current aperture, controller 252 may adjust to the first emission scheme for the next scanning point. At step 513, the second emission scheme is maintained for scanning the laser beam towards the current aperture. If controller 252 determines the current scanning point is not the last scanning point in the current aperture, controller 252 may maintain the second emission scheme for the next scanning point.

Like steps 508 and 512, steps 513, 515, and 517 may also each proceed to step 518 where the laser beam is moved/rotated towards the next scanning point. From step 518, based on whether laser beam 209 is scanned according to the first emission scheme or the second emission scheme, as determined in the previous steps, e.g., steps 508, 512, 513, 515, and 517, the operation is directed to step 502 to scan according to the first emission scheme or directed to step 519 to scan according to the second emission scheme.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A system for controlling an emission of laser beams by an optical sensing device, the system comprising:
a controller, configured to:
detect an object within a field of view of the optical sensing device based on a laser beam reflected by the object and received by the optical sensing device, wherein the laser beam is emitted at a current scanning point according to a first laser emission scheme;
determine a distance of the object from the optical sensing device based on the reflected laser beam; and
in response to the distance being within a functional distance range, control the optical sensing device to emit laser beams according to a second laser emission scheme towards an aperture extending from the current scanning point, wherein the second laser emission scheme reduces a number of scanning points in the aperture towards which laser beams are emitted compared to the first laser emission scheme.

2. The system of claim 1, wherein the controller is further configured to determine the number of scanning points in the aperture for the second laser emission scheme based on an upper limit of scanning points per frame being safe to a human eye.

3. The system of claim 2, wherein to control the optical sensing device to emit laser beams according to the second laser emission scheme, the controller is configured to control the optical sensing device to emit laser beams towards a subset of scanning points in the aperture according to the first laser emission scheme and skip the remaining scanning points in the aperture according to the first laser emission scheme.

4. The system of claim 1, wherein the optical sensing device is configured to perform two-dimensional scanning, wherein the aperture extends along both scanning directions from the current scanning point.

5. The system of claim 4, wherein a size of the aperture is sufficient to cover an area of a human pupil.

6. The system of claim 1, wherein
an area of the laser beam at the optical sensing device is equal to or greater than a predetermined area associated with a human pupil; and
at a distance limit of the functional distance range, the area of the laser beam is equal to 2.5 times the area of the laser beam at the optical sensing device.

7. The system of claim 6, wherein the aperture is a square area having a length of 7 mm along a lateral scanning direction and a width of 7 mm along a vertical scanning direction.

8. The system of claim 7, wherein according to the second laser emission scheme, the controller is configured to control the optical sensing device to emit lasers towards six scanning points along the lateral scanning direction and the vertical scanning direction, the six scanning points being evenly distributed in the aperture.

9. The system of claim 1, wherein the controller is further configured to:
detect another object within the functional distance range from the optical sensing device based on a laser beam emitted towards a new scanning point in the aperture according to the laser second emission scheme and reflected by the other object, wherein the new scanning point is different from the current scanning point; and
control the optical sensing device to emit laser beams according to the second laser emission scheme in another aperture extending from the new scanning point.

10. The system of claim 1, wherein the controller is further configured to:
control the optical sensing device to emit laser beams according to the first laser emission scheme outside the aperture.

11. The system of claim 1, wherein an energy of the laser beam emitted towards the object is less than or equal to a safety limit.

12. A method for controlling an emission of laser beams by an optical sensing device, comprising:
detecting an object within a field of view of the optical sensing device based on a laser beam reflected by the object and received by the optical sensing device, wherein the laser beam is emitted at a current scanning point according to a first laser emission scheme;
determining a distance of the object from the optical sensing device based on the reflected laser beam; and
in response to the distance being within a functional distance range, controlling the optical sensing device to emit laser beams according to a second laser emission scheme towards an aperture extending from the current scanning point, wherein the second laser emission scheme reduces a number of scanning points in the aperture towards which laser beams are emitted compared to the first laser emission scheme.

13. The method of claim 12, wherein controlling the optical sensing device to emit laser beams according to the second laser emission scheme comprises controlling the optical sensing device to emit laser beams towards a subset of scanning points in the aperture according to the first laser emission scheme and skip the remaining scanning points in the aperture according to the first laser emission scheme.

14. The method of claim 12, wherein the optical sensing device is configured to perform two-dimensional scanning, wherein the aperture extends along both scanning directions from the current scanning point and sufficient to cover an area of a human pupil.

15. The method of claim 12, wherein:
an area of the laser beam at the optical sensing device is equal to or greater than a predetermined area associated with a human pupil; and
at a distance limit of the functional distance range, the area of the laser beam is equal to 2.5 times the area of the laser beam at the optical sensing device.

16. The method of claim 15, wherein:
the aperture is a square area having a length of 7 mm along a lateral scanning direction and a width of 7 mm along a vertical scanning direction.

17. The method of claim 16, wherein according to the second laser emission scheme, the method comprises controlling the optical sensing device to emit lasers towards six scanning points along the lateral scanning direction and the vertical scanning direction, the six scanning points being evenly distributed in the aperture.

18. The method of claim 12, wherein the method further comprises:
detecting another object within the functional distance range from the optical sensing device based on a laser beam emitted towards a new scanning point in the aperture according to the second laser emission scheme and reflected by the other object, wherein the new scanning point is different from the current scanning point; and
controlling the optical sensing device to emit laser beams according to the second laser emission scheme in another aperture extending from the new scanning point.

19. The method of claim 12, wherein the method further comprises:
controlling the optical sensing device to emit laser beams according to the first laser emission scheme outside the aperture.

20. A non-transitory computer-readable medium having instructions stored thereon, wherein the instructions, when executed by at least one processor, cause the at least one processor to perform a method for controlling an emission of laser beams by an optical sensing device, the method comprising:
detecting an object within a field of view of the optical sensing device based on a laser beam reflected by the object and received by the optical sensing device, wherein the laser beam is emitted at a current scanning point according to a first laser emission scheme;
determining a distance of the object from the optical sensing device based on the reflected laser beam; and
in response to the distance being within a functional distance range, controlling the optical sensing device to emit laser beams according to a second laser emission scheme towards an aperture extending from the current scanning point, wherein the second laser emission scheme reduces a number of scanning points in the aperture towards which laser beams are emitted compared to the first laser emission scheme.
